(19) United States
(12) Patent Application Publication
(10) Pub. No.: US 2015/0172804 A1
(43) Pub. Date: Jun. 18, 2015

(54) Customizable Multi-Directional Anchoring Fit Earphones

(71) Applicants: Judd Armstrong, Salt Lake City, UT (US); Steve Duddy, Varsity Lakes (AU)

(72) Inventors: Judd Armstrong, Salt Lake City, UT (US); Steve Duddy, Varsity Lakes (AU)

(21) Appl. No.: 13/736,900

(22) Filed: Nov. 20, 2013

Related U.S. Application Data
(60) Provisional application No. 61/631,721, filed on Jan. 9, 2012.

(51) Int. Cl. H04R 1/10

(52) U.S. Cl. CPC H04R 1/1058; H04R 1/1016

(57) ABSTRACT

The inventions relates to a device for providing a precise earphone fit to any user's ear. It provides multi-directional anchoring points to ensure that any user can adjust the earphones to fit their unique ear shape. As a result, the earphones can be worn and remain secure even during strenuous activities.

### CROSS REFERENCE TO RELATED APPLICATION

This application claims the benefit of U.S. Provisional Application Ser. No. 61/631,721 filed Jan. 9, 2012 by Judd Armstrong and Steve Duddy.

### FIELD OF THE INVENTION

The present invention relates generally to the field of customizable fit earphones, and more particularly to customizable fit earphones that use multi-directional anchoring to ensure a proper and secure fit.

### BACKGROUND OF THE INVENTION

With the proliferation of portable digital music players, more and more people are using earphones as part of their daily activities, including cleaning, exercising, commuting and various other activities. Because each person's ear is as unique as their fingerprints, earphones that are mass produced do not always, or even usually, fit each unique user's individual ear. This leads to users having to constantly adjust their earphones to make sure they are staying in their ear and so they can hear audio through the earphones. This becomes especially annoying when a user is engaged in strenuous activity. Others have attempted to fix this problem by changing the earphone's ear tips or by modifying the placement of the wire. Some have even attempted to provide a device that wraps around the outside of the wearer's ear. None of these approaches permits a user to customize the fit of the earphone to their unique ear shape using multi-directional anchoring.

Existing over ear earphones do not provide effective bottom/back anchor points for active use. The earphones are elongated backwards but are too rigid, set sized, and/or bulky to offer any spring-type resistance grip to ear. They are not intended to offer backward anchoring as they are offered in just one size. One size fits all is simply not a practical or marketable solution.

There is a need for earphones that permit the wearer to create a customizable fit using multi-directional anchoring. The present invention provides multi-directional anchoring ensuring that an earphone stays in place even when the user is engaged in strenuous activity.

### SUMMARY OF THE INVENTION

This invention provides anchoring in multiple directions (front, back, top and bottom) for earphones worn on the ear (wired or wireless) while providing a customizable fit for the wearer by utilizing a length adjustable cord instead of a set-sized tooled part.

In one aspect of the invention, it provides improved earphones that can be easily customized to fit each individual's unique ear shape.

In another aspect of the invention, it provides earphones that will stay securely fit on the wearer's head even during strenuous activity.

In another aspect of the invention, it provides earphones that permit the wearer to adjust to their particular comfort levels, permitting the earphone to be worn for long periods of time.

To the accomplishment of the above and related aspects, the invention may be embodied in the form illustrated in the accompanying drawings. The drawings, however, are illustrative only. Variations are contemplated as being part of the invention, limited only by the scope of the claims.

### BRIEF DESCRIPTION OF THE DRAWINGS

FIG. 1 is a drawing of the average ear.

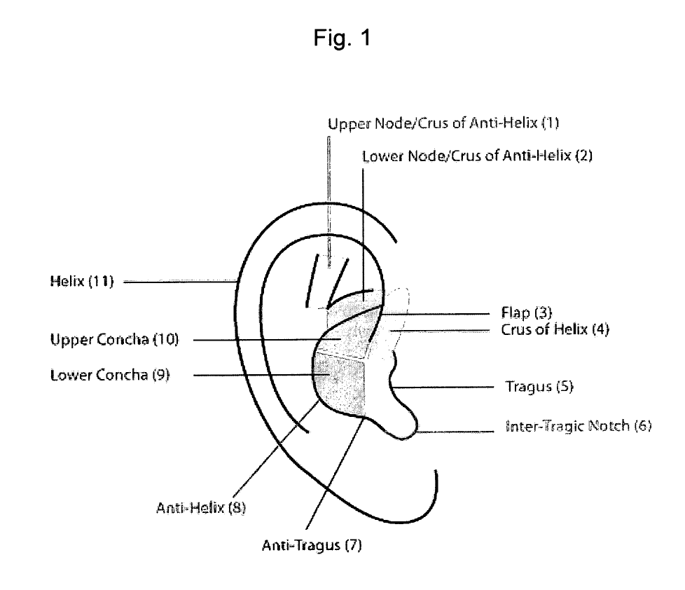

FIG. 2 is a perspective view of the present invention being worn in an ear.

### DETAILED DESCRIPTION OF THE INVENTION

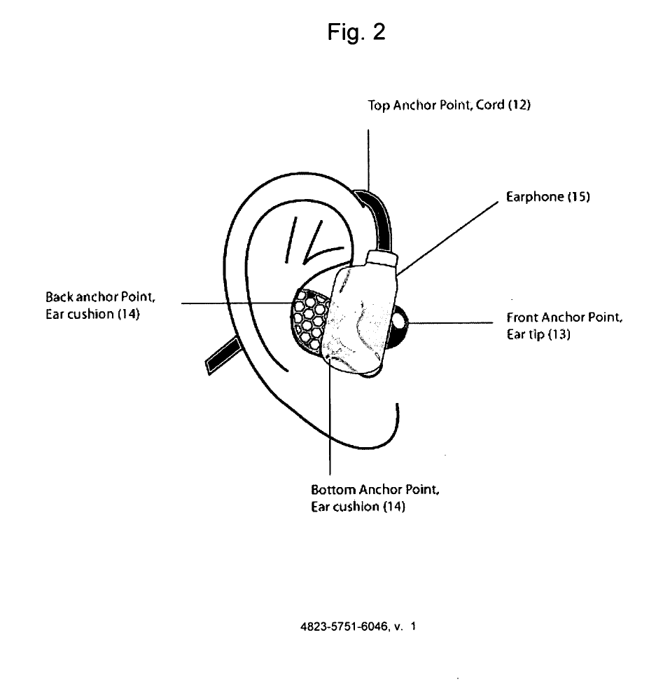

As shown in FIG. 2, the front anchor point (17) is provided by the eartip (13) being held behind the tragus of the ear (5). Eartip (13) can be made in various shapes and sizes to permit proper fit to each unique wearer. The back (19) and bottom (18) anchors are provided by ear cushion (14) being held behind the anti-tragus (7) and anti-helix (8) in the lower part of the concha (9). Ear cushion (14) can also be made in various shapes and sizes to permit precise fit. The top anchor point (16) is formed where the cord (12) exits the earphone (15) at top, and runs over the point where the helix (11) attaches to the head, then back behind the outer ear. The cord (12) can be secured by various means, including, but not limited to, memory wire inside the cord, a part which resides on the cord for adjusting length/tightness to head, or just the weight/shape of the cord itself. By adjusting the cord length, the user can precisely adjust the tightness of the top anchor point. The customizable top anchor point (12) location created by the adjustable cord length maximizes proper fit as each ear is unique in size and shape. The distance between the top anchor location (16) on the ear and the other anchor location points (17, 18, 19) varies significantly on every person's ear. This invention caters to any variation of those distances on each individual user's ear. A user can even adjust the fit to accommodate the differences between his or her own ears.

Where existing earphones feature an eartip and backside ear cushion which handles front and lower anchoring, the backside anchoring is inadequate. This is addressed by the present invention's use of back anchor point (19). Existing earphones also do not have customizable top anchor point (16) but instead use a rigid over-ear hook. The adjustable cord (12) used at top anchor point (16) provides for complete customization of size and fit for securing.

Back anchor point (19) does not utilize upper concha (10) and does not project underneath flap (3) as do existing earphones, which earflap use can become uncomfortable over periods of prolonged use. Instead, the present invention uses the cord (12) at top anchor point (16) instead of the upper part of the C shape of an ear. Some ears do not have a sufficient lip around the lower node of the anti-helix (2) for a full C shape ear cushion to secure the earphone, and some are uniquely shaped so that a C shape cannot be the only securing mechanism for the wearer. Having a cord (12) wrap over the ear at top anchor point (16) provides for earphones that are held securely to the ear in partnership with bottom (18), back (19) and front (17) anchor points.

What is claimed is:

1. Customizable fit earphones comprising:
a top anchor point;
a front anchor point;
a bottom anchor point; and
a back anchor point.

2. Customizable fit earphones comprising:
a cord providing a top anchor point;
an ear tip providing a front anchor point; and
an ear cushion providing bottom and back anchor points.

3. The customizable fit earphones of claim 2 wherein the cord is of adjustable length.

4. The customizable fit earphones of claim 2 wherein the cord is made with memory cord.
